(19) United States
(12) Patent Application Publication
(10) Pub. No.: US 2002/0181094 A1
(43) Pub. Date: Dec. 5, 2002

(54) Optical module for increasing magnification of microscope

(76) Inventor: Ronald J. Weinstock, Corona del Mar, CA (US)

Correspondence Address: MELVIN K. SILVERMAN, SUITE 440, 4901 NORTH FEDERAL HIGHWAY, FORT LAUDERDALE, FL, 33308, US

(21) Appl. No.: 10/158,258

(22) Filed: May 29, 2002

Related U.S. Application Data
(60) Provisional application No. 60/294,553, filed on May 30, 2001.

(51) Int. Cl. G02B 21/00

(52) U.S. Cl. 359/380; 359/368; 359/381; 359/431

(57) ABSTRACT

A multi-element folded optical train is provided for the increase of magnification of an optical microscope. The apparatus includes a plurality of reflective elements arranged to provide a continuous optical path through each of the reflective elements. The apparatus is employed as an intermediary between the objective and eyepiece of the optical microscope such that light from the objective passes through the various reflective elements and to the eyepiece.

### REFERENCE TO RELATED APPLICATION

This is a utility conversion under 35 U.S.C. 119 (e) of Provisional Application Serial No. 60/294,553, filed May 30, 2001. The same is hereby incorporated in full by reference.

### BACKGROUND OF THE INVENTION

1. Field of the Invention

The present invention relates to the field of optical microscopy, and more specifically to an apparatus for enhancing magnification.

2. Prior Art

The prior art in the area of optical microscopes that entails the use of prisms as reflectors to achieve an enhanced capability are, on the one hand, limited to systems seeking to create a dual objective as, for example, to view a specimen at either two different magnifications or from two different directions at the same time, and other hand, microscopes seeking to achieve a stereoscopic effect at the eyepiece thereof, that is, a three-dimensional viewing of a specimen. The prior art which reflects one or more of these goals is represented by U.S. Pat. Nos. 5,146,363 (1992) to Nagano; No. 5,701,198 (1997) to Schoppe; 5,764,408 (1998) to Otaki; and 6,134,01 (2000) to Zavislan.

Of the above, only the reference to Otaki exhibits any awareness of the capability of the use of reflecting and deflecting prisms to effect a change of the external size or geometry of the microscope itself. Also, none of these references, nor others known to the inventor, have suggested the use of selectable combinations and positioning of wedge or triangular prisms to effectively increase the length of the optical path between the eyepiece and the objective to thereby increase the magnification of the optical microscope.

### SUMMARY OF THE INVENTION

The inventive optical microscope comprises an objective, and eyepiece, which together with said objective provide magnification, and a plurality of reflective elements arranged to provide an optical path between said objective and eyepiece and to increase said magnification. This includes a method for increasing magnification of a microscope comprises an objective and an eyepiece that define an optical path therebetween. The method more particularly comprises: inserting a plurality of reflective elements between said objective and eyepiece; and arranging said plurality of reflective elements so as to fold said optical path between said objective and said eyepiece.

It is accordingly an object of the invention to provide a module for the enhancement of the magnification of an optical microscope.

It is another object to provide a system, inclusive of such a module which, by folding of the optical path, increases the effective length thereof and, with it, the magnification of the microscope.

It is a still further object of the invention to provide a method of increasing magnification of an optical microscope by providing a plurality of reflective elements, in the nature of prisms, between the objective and the eyepiece of the microscope, to effectively fold and, thereby, increase the optical path between the objective and the eyepiece of the system.

The above and yet other objects and advantages of the present invention will become apparent from the hereinafter set forth Brief Description of the Drawings, Detailed Description of the Invention and claims appended herewith.

### BRIEF DESCRIPTION OF THE DRAWINGS

FIG. 1 is a schematic view that shows a magnification module inserted into an optical microscope.

FIGS. 2 and 3 are schematic views of respective geometries of magnification modules each including a plurality of reflectors; and

FIG. 4 depicts a plurality of magnification modules cascaded together and inserted into the optical microscope.

### DETAILED DESCRIPTION OF THE INVENTION

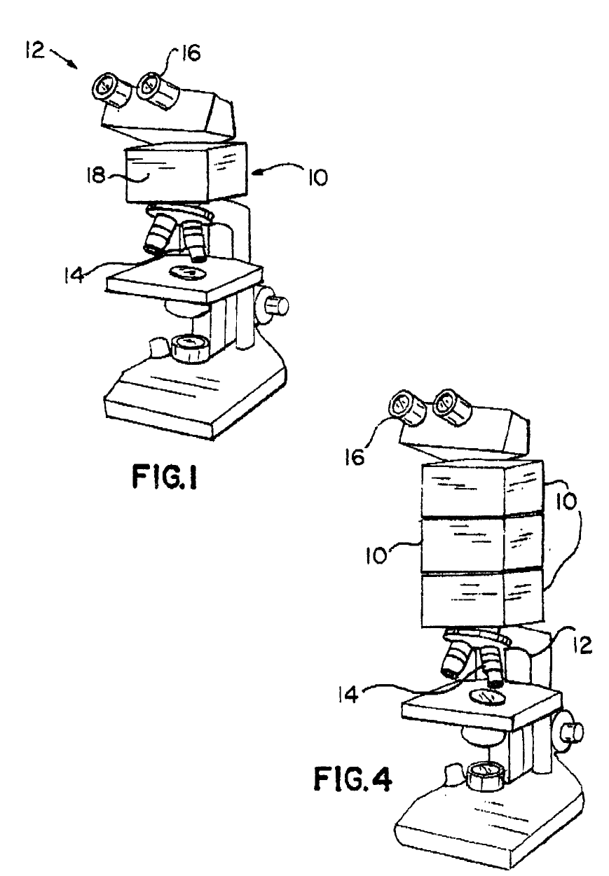

As shown in FIG. 1, an optical module 10 can be inserted into a microscope 12, or similar optical magnification system, to enhance its magnification. The microscope 12 shown in FIG. 1 comprises a standard light microscope having , e.g., between about 1000× and 4000× magnification. As is conventional, this microscope 12 comprises an objective 14, an eyepiece 16, and an optical path 18 extending therebetween. This optical path has a standard length of between about 160 to 190 millimeters (mm), conventionally referred to as the tube length. The optical module 10 is inserted between the objective 14 and eyepiece 16.

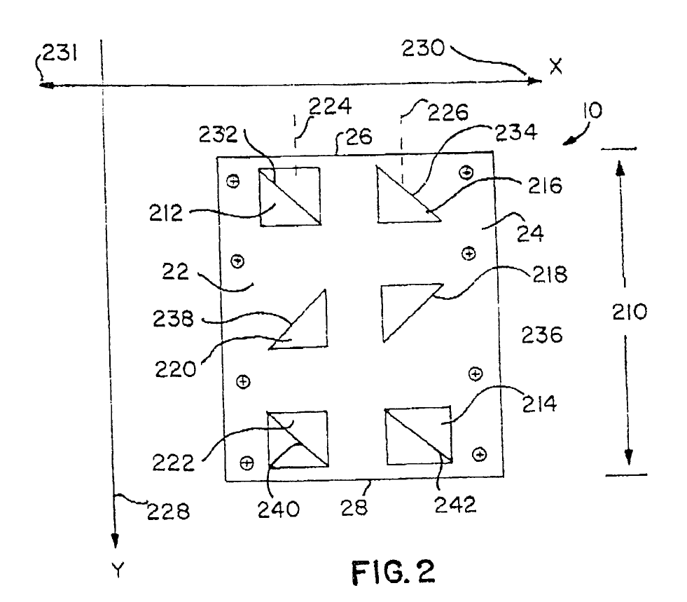

FIG. 2 shows one preferred embodiment of the optical module 10 comprising a plurality of reflective elements supported upon a frame 22 for use within an optical magnification system. The frame 22 comprises a top plate (not shown) and a bottom plate 24, the plurality of reflective elements being sandwiched therebetween. This frame 22 and, therefore the module 10 as well, are rectangular, having four sides, including two oppositely situated first 26 and second sides 28. The module 10 is inserted into the optical microscope 12 such that the first side 26 is adjacent the objective 14 and the second side 28 is near the eyepiece 16 of the microscope. The module 10 has a length 210 spanning from the first side 26 to the second side 28; this length 210 is small such that the module 10 can fit between the objective 14 and the eyepiece of the microscope 12.

To enhance the magnification, the module 10 is inserted into a microscope 12 and aligned such that light from the object 14 passes through the module 10 and onto and through the eyepiece 16. The reflective elements in the module 10 are arranged to direct light through the optical module 10. For example, the light from the objective 14 preferably reflects off of a first reflective element 212 mounted on the frame 22 of the module 10. This first reflective element 212 reflects the beam to another reflective element which will deflect the beam to yet another reflective element and so forth until the beam reaches a final reflective element 214 mounted near the second side 28 of the module 10. The last reflective element 214 preferably directs the beam to the eyepiece 16. Rays of light from an object below the objective 14 will therefore transverse a path between the objective and the eyepiece 16 that is longer than if the optical module 10 were removed. In effect, the module 10 will increase the optical path length between the objective 14 and the eyepiece 16 beyond that of the standard tube length. Alternatively, the optical path between the objective 14 and the eyepiece 16 may be said to be folded such that the space separating the objective from the eyepiece can accommodate a longer optical path length. The longer optical path is folded to fit into the small region between the objective 14 and the eyepiece 16.

Various arrangements of the reflective elements can be employed to fold the optical path between the objective 14 and the eyepiece 16 as shown in FIGS. 2 and 3. For example, in the embodiment depicted in FIG. 2, six reflective elements, a first 212, second 216, third 218, fourth 220, fifth 222, and sixth 214, are positioned on the frame 22 in two columns 224, 226, each column comprising three reflective elements. These two columns 224, 226 define a Y direction 228, shown in FIG. 2. The three elements are equally spaced in column along the Y direction 228. In addition, each element 212, 220, 222 in the first column 224 is aligned with a corresponding element 216, 218, 214 in the second column 226. The plurality of reflective elements 212-222 therefore comprises three rows, each row comprising two optical elements arranged along an X direction 230 which is orthogonal to said Y direction 228. The optical elements in each row are preferably spaced apart by a same distance as that separating adjacent elements in one of the columns.

The first reflective element 212, which is mounted on the frame 22 of the module 10, comprises a cube having a reflective surface 232 therein oriented at about 45° to the X direction 230 and Y direction 228, such that incident light will be reflected toward the second reflective element 216 in the X direction 230, which is the same row as the first reflective element 212.

The second element 216 comprises a triangular prism having a triangular cross-section and a reflective surface 234 also oriented at about 45° to the X direction 230 and Y direction 228 such that light will be reflected in the Y direction 228 toward the third reflective element 218 which is situated in the next row.

The third reflective element is similar to the second element 216, however the reflective surface 236 is oriented to direct light in a negative X direction 231 toward the fourth reflective element 220 which is in the same row as the third optical element 218. Accordingly, it has a reflective surface 238 at an approximately 45° angle with respect to the X direction 230 and Y direction 228, but that is orthogonal to the reflective surface 234 in the second reflective element 216.

The fourth reflective element 220 is similar to the third element 218, however the reflective surface 238 is oriented to direct light in the Y direction 228 toward the fifth reflective element 222 which is the next row. Thus, the reflective surface 238 in the fourth reflective element 210 is parallel to the reflective surface 236 in the third reflective element 218.

The firth reflective element 222 is similar to the fourth element 218, however the reflective surface 240 is perpendicular to that of the fourth element 238 to direct light in the X direction 230 toward the sixth reflective element 214, which is in that same row as the firth reflective element 222.

The sixth reflective element 214 also comprises a cube having a reflective surface 242 therein oriented at about 45° to the X direction 230 and Y direction 228. Light directed from the fifth reflective element 222 will be deflected from the sixth reflective element 214 in the Y direction 228 and will exit the optical module 10 and propagate toward the eyepiece 16. As discussed above, the resulting configuration of elements creates a folded optical path wherein an input of light at the first element 212 will traverse a greater distance through each of the six optical elements 212 to 222 than it would otherwise, directly from the objective 14 to the eyepiece 16, had the optical module 10 not been inserted therein.

Note also that although six reflective elements 212 to 222 are employed in the embodiment of FIG. 2, the design of the optical module 10 is not so limited, Fewer or greater numbers of optical elements may be employed to increase the optical path length. At least part of this system of reflectors, such as for example the combination of elements two 216, three 218, four 210, and five 222, may be repeated one or multiple times to generate increasingly long optical path lengths in one apparatus. In other embodiments, the optical path may span several layers of the optical module, for example in the vertical direction, to further increase path length without increasing overall length and width of the module.

As shown in FIG. 2, the first 212 and sixth 214, optical elements are similar in this embodiment. In preferred embodiments of the invention, one or both elements may comprise a prism, having a reflective interface therein. The elements comprise a transparent media with a reflective surface formed within; in such cases, the media provides efficient transmission of light with low attenuation, and preferably minimal chromatic aberration.

The second 216, third 218, fourth 220, and fifth 222 optical elements are all similar as well; generally comprising a prism having a triangular shape. These elements may be configured such that light is incident on a flat surface of the prism, and subsequently propagates through the prism toward a reflective surface that is angled; e.g., at approximately 45° with respect to the direction of propagation, where the beam of light is reflected and propagated through the prism before emission from another surface in a direction which is approximately 90° to the initial direction of the incoming beam. In other embodiments, the reflective surface of the element may be coated with a specularly reflective material, such as aluminum to enhance the reflective capabilities of the element. The elements are preferably made from an optically clear material which provides efficient transmission for light and low chromatic aberration.

In other embodiments, any number of elements may comprise other types of reflective elements such as mirrors, more preferably of the first-surface reflective type. For example, a first-surface reflector, oriented at approximately 45° to the direction of the light path, would reflect light in a desired direction within the module eliminating the phase transition of the light associated with prism type optical elements. In combination with one or more reflective or refractive elements, these reflectors may create a desired folded optical path for the module.

In the embodiment of FIG. 2, the elements 212 to 222 are approximately one inch in height, width and length. As such, they define an aperture one inch square which limits or stops down the beam of light transversing from the objective 14 to the eyepiece 16. The optical elements 212 to 222 are located equally spaced apart in each column 224, 226 and in each row by approximately one inch. The apparatus 10 is therefore approximately five inches long by four inches wide. The elements 212 to 222 are mounted on a substrate or frame 22 which is capable of supporting the elements, and are fastened to the frame 22 in a way which will retain the position of the elements, and preferably prevent any vibrations, or other mechanical disturbances of the elements.

FIG. 3 shows another embodiment of the optical module 10. In this embodiment, the module 10 comprises six optical elements defining three columns. The first 31 and the sixth 33 elements are positioned in the same column 35 oriented in the Y direction 37 of the module 30. The second 39 and third 311 elements are positioned in a second column 313 parallel to the first column 35 of the module 10 and the fourth 315 and fifth 317 optional elements are positioned in a third column 319 also parallel to the first 35 and second columns 313 The first column 35 is located centrally on the apparatus 10, flanked by the second 313 and third 319 columns which are parallel to the first column 35. The first 31 and sixth 33 optical elements are of the quartz prism type described above, but may be or another preferable reflective type; such as a mirror. The second 39, third 311, fourth 315, and fifth 317 elements may all be of the prism type, described above having reflective surfaces oriented at about 45° to their respective optical axis, or of the mirror type described above, or any combination of the many different types of reflectors which may be used to accomplish the same object. In FIG. 3, the overall apparatus maybe for example about 60 mm in length, and width. The elements of the system 10 may vary in spacing from about 20 to 30 mm, or in arrangement thereof, while not interfering with the effectiveness of the system. The system 10 of optical elements, such as the combination of the second 39, third 311, fourth 315, and fifth 317 elements, is used to create a folded optical path which may be repeated one, or multiple times, to generate increasingly long optical path lengths in one apparatus.

In FIG. 3, light is incident on the first optical element 31 in the Y direction 27 where it is reflected orthogonally toward the second optical element 39 in the X direction 321. The second optical element 39 will reflect incident light along the second column in the Y direction 37, towards the third optical element 311. The third element 311 will reflect incident light from the second element 39 orthogonally toward the fourth element 315, in the negative X direction 322. The fourth element 315 will reflect incident light along the third column 319 in the Y direction 37 toward the fifth optical element 317. The fifth optical element 317 will reflect light from the fourth element 315 in the X direction 321 toward the sixth element 33. The sixth element 33 will reflect light from the fifth element 317, in the Y direction 37 for emission from the apparatus 10.

As described above, the optical module 10 is intended for use within an optical microscope 12. The invention is inserted between an objective 14 and an eyepiece 16, In a typical microscope 12, light gathered from the sample by the objective 14, would be propagated to the eyepiece 16 directly, in the embodiments described above, such light gathered by the objective would be incident onto the first element 212, 31 of the module. The eyepiece 16 is then positioned to gather light emitted from the final element 214, 33 in the module. In a preferred embodiment, the eyepiece 16 is in close proximity to the final element 214, 33 of the apparatus 10, while the objective 14 is located adjacent the first element 212, 31, in the apparatus. In other embodiments, for example, the light is projected from the objective 14 no more than 30 mm before it is incident on the first optical element 212, 31 in the module 10. The light beam is then bent at right angles.

The configurations described above greatly enhance magnification beyond what is provided by the objective 14 and eyepiece 16 as arranged in the optical microscope 12 without the module inserted therein. The optical microscope 12 can be used with microscopes that employ other specialized microscopy techniques such as fluorescent and polarization microscopy.

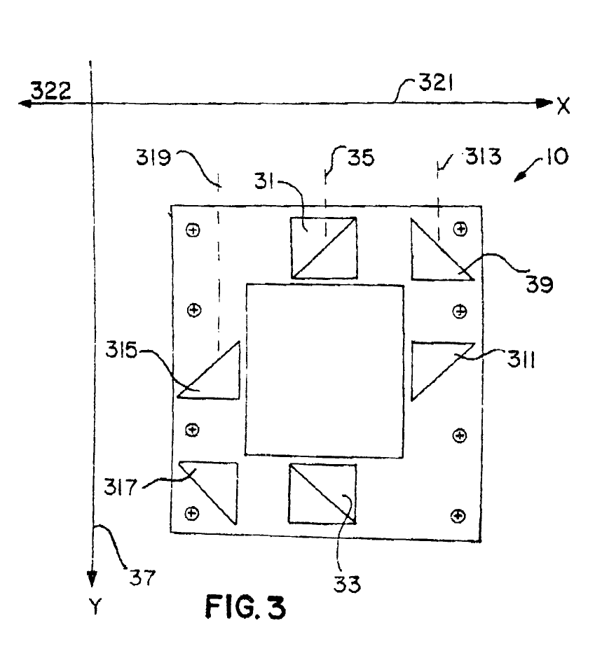

Additionally, many of these modules 10 may be used in series to increase the magnification further. This series may comprise many modules, or a single module with, for example, a very long optical path. FIG. 4 depicts a plurality of optical module 10, such as those described with reference to FIGS. 2 and 3, that are cascaded to provide a long folded optical path between the objective 14 and the eyepiece 16.

Although described above in connection with particular embodiments of the present invention, it should be understood that the description to the embodiments are illustrative of the invention and are not intended to be limiting. Accordingly, various modifications and applications may occur to those skilled in the art without departing from the true spirit and scope of the invention.

1. An optical module for increasing magnification of a microscope comprising an objective and an eyepiece defining a first optical path for light to travel from said objective to said eyepiece, said optical module comprising:
a plurality of reflective elements including a first and a last reflective element, each reflective element having a reflective surface and being arranged so as to define a second optical path from said objective to said eyepiece when said module is inserted in said optical microscope,
wherein said second optical path is longer that said first optical path.

2. The optical module of claim 1, wherein said plurality of reflective elements comprise at least four reflective elements.

3. The optical module of claim 1, wherein said reflective elements comprise prisms with at least one reflective surface.

4. The optical module of claim 1, wherein said reflective elements comprise mirror.

5. An optical microscope comprising:
an objective;
an eyepiece, which together with said objective provide magnification; and
a plurality of reflective elements arranged to provide an optical path between said objective eyepiece and to increase said magnification.

6. A method for increasing magnification of a microscope comprising objective and an eyepiece that define an optical path therebetween, said method comprising:
inserting a plurality of reflective elements between said objective and eyepiece; and
arranging said plurality of reflective elements so at to fold said optical path between said objective and said eyepiece.
